(19) United States
(12) Patent Application Publication
(10) Pub. No.: US 2009/0154541 A1
(43) Pub. Date: Jun. 18, 2009

(54) TRANSMITTER, RECEIVER AND COMMUNICATION TERMINAL SYSTEM

(76) Inventors: Takayuki INAGAKI, Osaka (JP); Tadao Inoue, Hyogo (JP); Shinya Murakami, Kyoto (JP); Shuuji Kamiya, Kyoto (JP)

Correspondence Address: MCDERMOTT WILL & EMERY LLP, 600 13TH STREET, NW, WASHINGTON, DC, 20005-3096, US

(21) Appl. No.: 12/332,798

(22) Filed: Dec. 11, 2008

(30) Foreign Application Priority Data
Dec. 17, 2007 (JP) 2007-324631

(51) Int. Cl. H04B 17/00; H04L 1/02; H04B 1/06

(52) U.S. Cl. 375/228; 375/295; 375/224; 375/340

(57) ABSTRACT

The transmitter for conducting communication with a receiver using a pulse train includes: a transmission frame generation section for generating a transmission frame; a pulse transmission timing generation section for generating pulse transmission timing to have intervals initially set to be the same as intervals at which the receiver receives pulses; and a pulse generation section for generating pulses according to the transmission frame and the pulse transmission timing.

### CROSS-REFERENCE TO RELATED APPLICATIONS

This application claims priority under 35 U.S.C. §119 on Patent Application No. 2007-324631 filed in Japan on Dec. 17, 2007, the entire contents of which are hereby incorporated by reference.

### BACKGROUND

The present disclosure relates to a communication technology using an impulse-like signal that is a wideband signal.

With the recent progress of computerization, local area networks (LANs) have become widespread. In particular, a wireless LAN, among others, has increasingly become popular because the installation period can be shortened and an apparatus connected with the network can be moved easily. Ultra wideband (UWB) wireless transmission is known as a wireless transmission scheme used for wireless LANs. The UWB wireless transmission scheme is described in Nikkei Electronics Aug. 26, 2002, Nikkei B P, pp. 137-144 and Nikkei Electronics Feb. 17, 2003, Nikkei B P, pp. 95-121.

As one type of the UWB wireless transmission scheme, an impulse-UWB transmission scheme is known in which transmission is made using a signal made of a pulse train having a pulse width of several nanoseconds (ns). In the impulse-UWB transmission scheme, in which a pulse train is directly transmitted without use of a carrier wave, reception is made in synchronization with periodically transmitted pulses, and thus power consumption can be reduced.

FIG. 12 is a view illustrating a state in which a plurality of communication terminal systems adopting the impulse-UWB transmission scheme exist. In FIG. 12, a transmitter 91 and a receiver 92 constitute one communication terminal system, and a transmitter 93 and a receiver 94 constitute another communication terminal system. The receivers 92 and 94 are assumed to be at positions where signals transmitted from both the transmitters 91 and 93 are receivable.

In the communication environment described above, if the transmitters 91 and 93 start transmission of pulses at the same pulse intervals and at the same timing, interference will occur between the pulses transmitted from the transmitters 91 and 93 successively (i.e., every pulse). Since, the receivers 92 and 94 conduct reception in synchronization with pulses from the respective communication partners, the reception performances of the receivers 92 and 94 will deteriorate due to the interference.

### SUMMARY

The example transmitter, the example receiver and the example communication terminal system may be advantageous in reducing interference occurring with a pulse transmitted from a transmitter other than a specific transmitter.

The transmitter of an embodiment of the present invention is a transmitter for conducting communication with a receiver using a pulse train, including: a transmission frame generation section for generating a transmission frame; a pulse transmission timing generation section for generating pulse transmission timing to have intervals initially set to be the same as intervals at which the receiver receives pulses; and a pulse generation section for generating pulses according to the transmission frame and the pulse transmission timing generated by the pulse transmission timing generation section.

With the above configuration, the transmitter transmits pulses at the same intervals as those at which the receiver receives pulses. This makes it possible to reduce interference occurring in the receiver with a pulse transmitted from another transmitter.

The receiver of an embodiment of the present invention is a receiver for conducting communication with a transmitter using a pulse train, including: a pulse reception timing generation section for generating pulse reception timing to have intervals initially set to be the same as intervals at which the transmitter transmits pulses; an amplifier for amplifying a received signal according to the pulse reception timing generated by the pulse reception timing generation section; a detector for demodulating a signal amplified by the amplifier and outputting the demodulation result; an accumulation section for accumulating an output of the detector and outputting the accumulation result; and a frame demodulation section for demodulating an output of the accumulation section and outputting a reception frame obtained.

With the above configuration, the receiver receives pulses at the same intervals as those at which the transmitter transmits pulses. This makes it possible to reduce interference occurring in the receiver with a pulse transmitted from another transmitter.

The communication terminal system of an embodiment of the present invention is a communication terminal system having a transmitter and a receiver for conducting communication using a pulse train. The transmitter includes: a transmission frame generation section for generating a transmission frame; a pulse transmission timing generation section for generating pulse transmission timing to have initially set intervals; and a pulse generation section for generating pulses according to the transmission frame and the pulse transmission timing generated by the pulse transmission timing generation section. The receiver includes: a pulse reception timing generation section for generating pulse reception timing to have intervals initially set to be the same as intervals at which the transmitter transmits pulses; an amplifier for amplifying a received signal according to the pulse reception timing generated by the pulse reception timing generation section; a detector for demodulating a signal amplified by the amplifier and outputting the demodulation result; an accumulation section for accumulating an output of the detector and outputting the accumulation result; and a frame demodulation section for demodulating an output of the accumulation section and outputting a reception frame obtained.

With the above configuration, the intervals at which the transmitter transmits pulses and the intervals at which the receiver receives pulses can be made the same. It is therefore possible to reduce interference occurring in the receiver with a pulse transmitted from another transmitter.

According to an embodiment of the present invention, it is possible to reduce interference occurring with a pulse transmitted from a transmitter other than a specific transmitter. In particular, the receiver can be prevented from being subjected to continuous interference.

### BRIEF DESCRIPTION OF THE DRAWINGS

FIG. 1 is a block diagram of a transmitter of an embodiment of the present invention.

FIG. 2 is a block diagram of a receiver of an embodiment of the present invention.

FIG. 3 is a view illustrating a state in which a plurality of transmitters substantially same as the transmitter of FIG. 1 and a plurality of receivers substantially same as the receiver of FIG. 2 exist.

FIG. 4 is a timing chart showing three examples of pulse transmission patterns.

FIG. 5 is a view illustrating an exemplary transmission frame.

FIG. 6 is a view illustrating another exemplary transmission frame.

FIG. 7 is a view illustrating an exemplary random number pattern used as a pulse transmission pattern.

FIG. 8 is a view illustrating an exemplary transmission frame having null data.

FIG. 9 is a block diagram of a receiver of an alteration to the embodiment of the present invention.

FIG. 10 is a view illustrating a state in which a plurality of transmitters of an alteration to the embodiment of the present invention and a plurality of receivers substantially same as the receiver of FIG. 9 exist.

FIG. 11 is a block diagram showing a display device and the receiver of FIG. 9 connected therewith.

FIG. 12 is a view illustrating a state in which a plurality of communication terminal systems adopting the impulse-UWB transmission scheme exist.

### DESCRIPTION OF THE PREFERRED EMBODIMENTS

Hereinafter, embodiments of the present invention will be described with reference to the accompanying drawings.

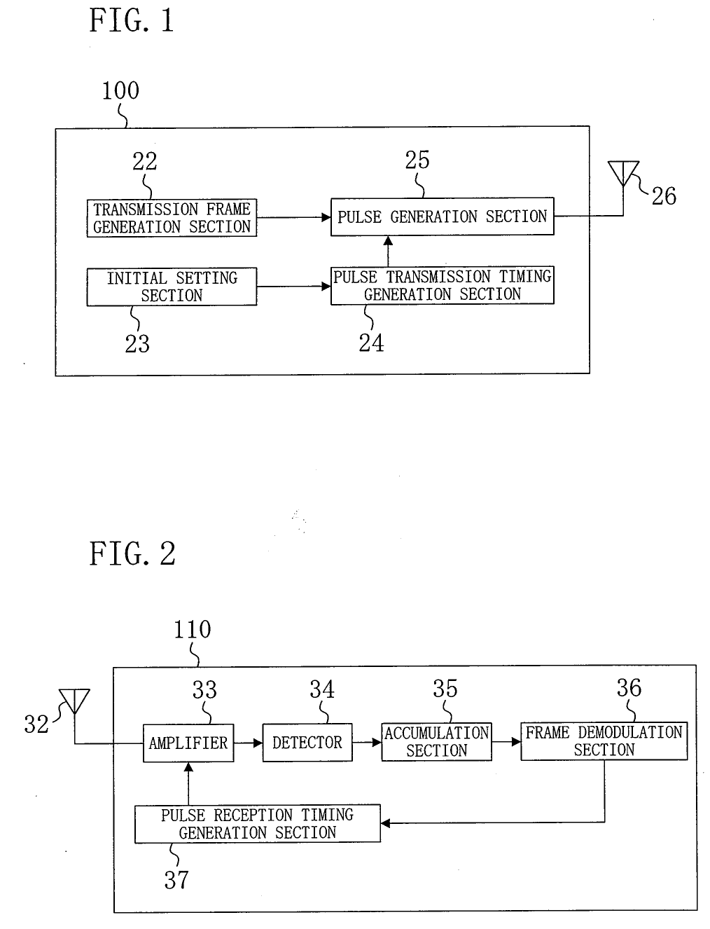

FIG. 1 is a block diagram of a transmitter 100 of an embodiment of the invention. FIG. 2 is a block diagram of a receiver 110 of an embodiment of the present invention. The transmitter 100 of FIG. 1, adapted to conduct communication with the receiver 110 by the impulse-UWB transmission scheme using a pulse train, includes a transmission frame generation section 22, an initial setting section 23, a pulse transmission timing generation section 24 and a pulse generation section 25.

The transmission frame generation section 22 generates a transmission frame and outputs the generated transmission frame to the pulse generation section 25. The initial setting section 23 selects a given value from a plurality of settable pulse interval values and outputs the selected value to the pulse transmission timing generation section 24 as the initial set value. The pulse transmission timing generation section 24 generates pulse transmission timing to have intervals corresponding to the initial set value received from the initial setting section 23.

The pulse generation section 25 generates pulses according to the transmission frame received from the transmission frame generation section 22 and the pulse transmission timing received from the pulse transmission timing generation section 24, and outputs the generated pulses to a transmitter antenna 26. The transmitter antenna 26 transmits the pulses received from the pulse generation section 25.

The receiver 110 of FIG. 2, adapted to conduct communication with the transmitter 100 by the impulse-UWB transmission scheme using a pulse train, includes an amplifier 33, a detector 34, an accumulation section 35, a frame demodulation section 36 and a pulse reception timing generation section 37.

A receiver antenna 32 receives a transmitted signal and supplies the signal to the amplifier 33. The pulse reception timing generation section 37 generates pulse reception timing and outputs the generated timing to the amplifier 33. The amplifier 33 amplifies the signal received from the receiver antenna 32 according to the timing received from the pulse reception timing generation section 37. The detector 34 demodulates the amplified signal received from the amplifier 33 and outputs the demodulation result. The accumulation section 35 accumulates the output of the detector 34 and outputs the accumulation result.

The frame demodulation section 36 demodulates the output of the accumulation section 35 to obtain a reception frame and outputs the obtained reception frame. The frame demodulation section 36 also extracts data from the obtained reception frame as required and outputs the extracted data to the pulse reception timing generation section 37.

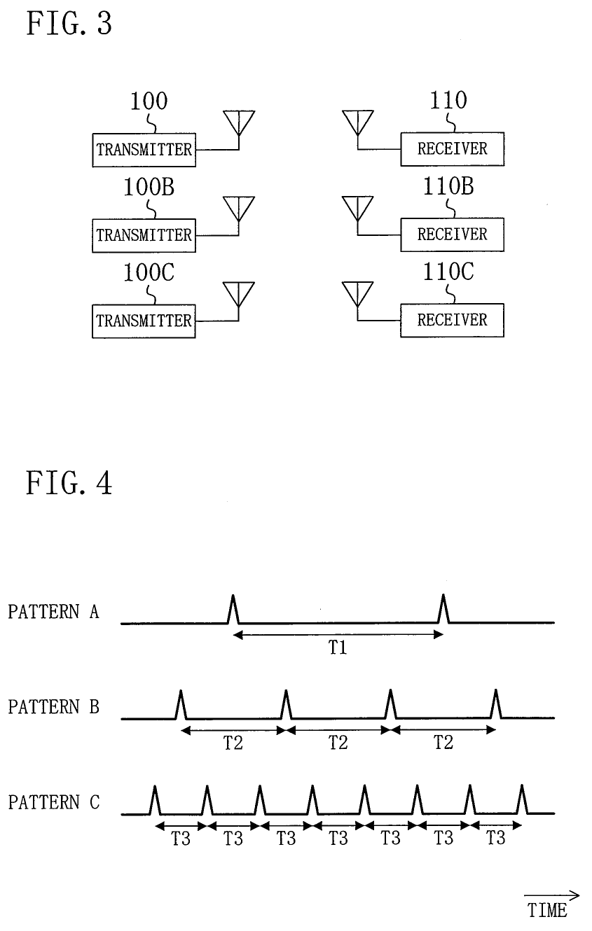

FIG. 3 is a view illustrating a state in which a plurality of transmitters substantially same as the transmitter of FIG. 1 and a plurality of receivers substantially same as the receiver of FIG. 2 exist. Transmitters 100B and 100C are roughly the same in configuration as the transmitter 100, and receivers 110B and 110C are roughly the same in configuration as the receiver 110.

FIG. 4 is a timing chart showing three exemplary pulse transmission patterns. Patterns A, B and C in FIG. 4 respectively have pulse intervals T1, T2 and T3 at which pulses are repeated.

The transmitter 100 and the receiver 110 constitute one communication terminal system and both have the pulse interval T1 as the initial set value. In other words, the initial setting section 23 of the transmitter 100 outputs the initial set value indicating the pulse interval T1, to allow the transmitter 100 to transmit pulses at the timing of the pattern A in FIG. 4. The pulse reception timing generation section 37 of the receiver 110 generates timing to have the pulse intervals T1, to allow the receiver 110 to receive the pulses at the timing of the pattern A.

The transmitter 100B and the receiver 110B constitute one communication terminal system and both have the pulse interval T2 as the initial set value. In other words, the transmitter 100B transmits pulses at the timing of the pattern B in FIG. 4, and the receiver 110B receives the pulses at the timing of the pattern B. The transmitter 100C and the receiver 110C constitute one communication terminal system and both have the pulse interval T3 as the initial set value. In other words, the transmitter 100C transmits pulses at the timing of the pattern C in FIG. 4, and the receiver 110C receives the pulses at the timing of the pattern C.

Hence, since the transmitters transmit pulses at pulse intervals different from one another, each of the receivers 110, 110B and 110C can suppress an influence of interference with a pulse from a transmitter other than a specific transmitter as its communication partner even when the receiver is at a position where signals from a plurality of transmitters are receivable.

Note that when four pairs of transmitters and receivers are involved, pulse intervals different from one another may be set for these pairs in a similar manner.

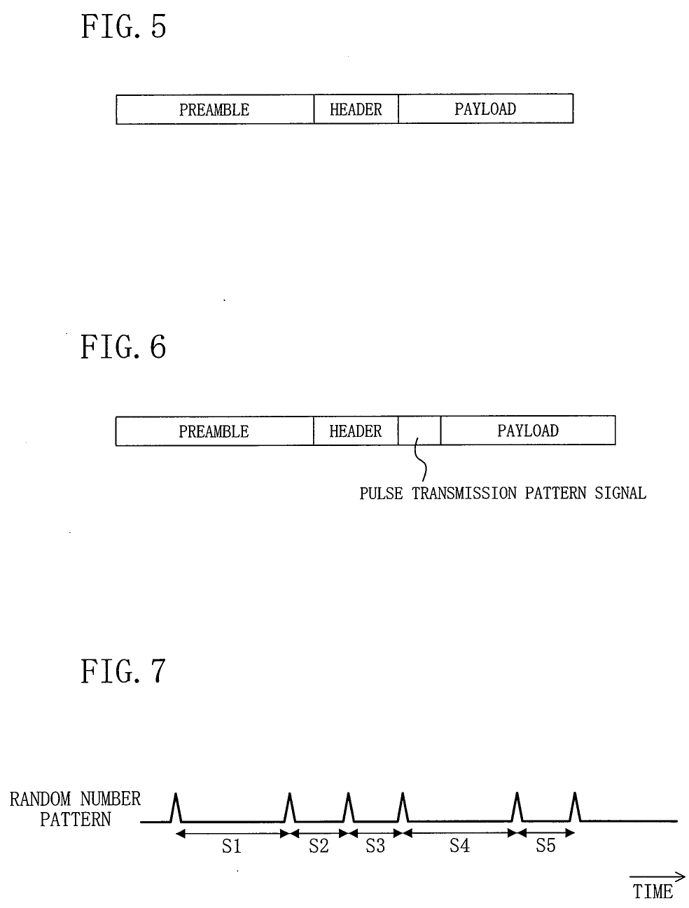

FIG. 5 is a view illustrating an example of the transmission frame. The entire transmission frame may be transmitted and received according to the initially set pulse interval. Alternatively, the transmission frame may be transmitted in the following manner. That is, in the transmitter 100, the pulse transmission timing generation section 24 may generate the pulse transmission timing according to a reference pattern for the preamble and header parts of the transmission frame of FIG. 5, and thereafter according to the initially set pulse interval for the payload part and any subsequent part of the frame. The reference pattern is a pattern having timing synchronizing with the operating clock, for example.

In the receiver 110, the pulse reception timing generation section 37 generates the pulse reception timing according to the same reference pattern as that used in the transmitter 100 for received pulses corresponding to the preamble and header parts, and thereafter according to the initially set pulse interval for the payload part and any subsequent part of the frame.

The configuration of the transmission frame may be different from that in FIG. 5. The position at which the pulse transmission timing and the pulse reception timing are changed may be moved to another position.

FIG. 6 is a view illustrating another example of the transmission frame. The transmission frame of FIG. 6 is different from the transmission frame of FIG. 5 in that the value indicating the initially set pulse interval is inserted between the header part and the payload part as a pulse transmission pattern signal. In transmission of the transmission frame of FIG. 6 by the transmitter 100, the pulse transmission timing generation section 24 generates the pulse transmission timing according to the reference pattern for the preamble part through the pulse transmission pattern signal in FIG. 6, and thereafter according to the initially set pulse interval for the payload part and any subsequent part of the frame.

In the receiver 110, receiving the transmission frame of FIG. 6, the pulse reception timing generation section 37 generates the pulse reception timing according to the same reference pattern as that used in the transmitter 100 for the preamble part through the pulse transmission pattern signal. The pulse reception timing generation section 37 then retrieves the pulse transmission pattern signal from the reception frame obtained so far by demodulation by the frame demodulation section 36, and selects a corresponding pulse interval from a plurality of settable pulse interval values. For the payload part and any subsequent part of the frame, the pulse reception timing generation section 37 generates the pulse reception timing according to the selected pulse interval.

Note that the pulse transmission pattern signal may be inserted at a position different from that in the transmission frame of FIG. 6.

FIG. 7 is a view illustrating an example of a random number pattern used as a pulse transmission pattern. The random number pattern of FIG. 7 includes a pulse train having pulse intervals S1, S2, S3, S4 and S5 between pulses in this order. The pulse intervals S1 to S5 correspond to numbers in a predetermined random number sequence.

The transmitter 100 may transmit pulses according to the random number pattern of FIG. 7, and the receiver 110 may receive these pulses. In other words, the pulse transmission timing generation section 24 may generate the pulse transmission timing according to a random number pattern as shown in FIG. 7 based on a previously set random number sequence. Also, the pulse reception timing generation section 37 may generate the pulse reception timing according to the same random number pattern as that used in the transmitter 100 based on the previously set random number sequence.

In place of the random number pattern of FIG. 7, another random number pattern may be used.

(Alteration)

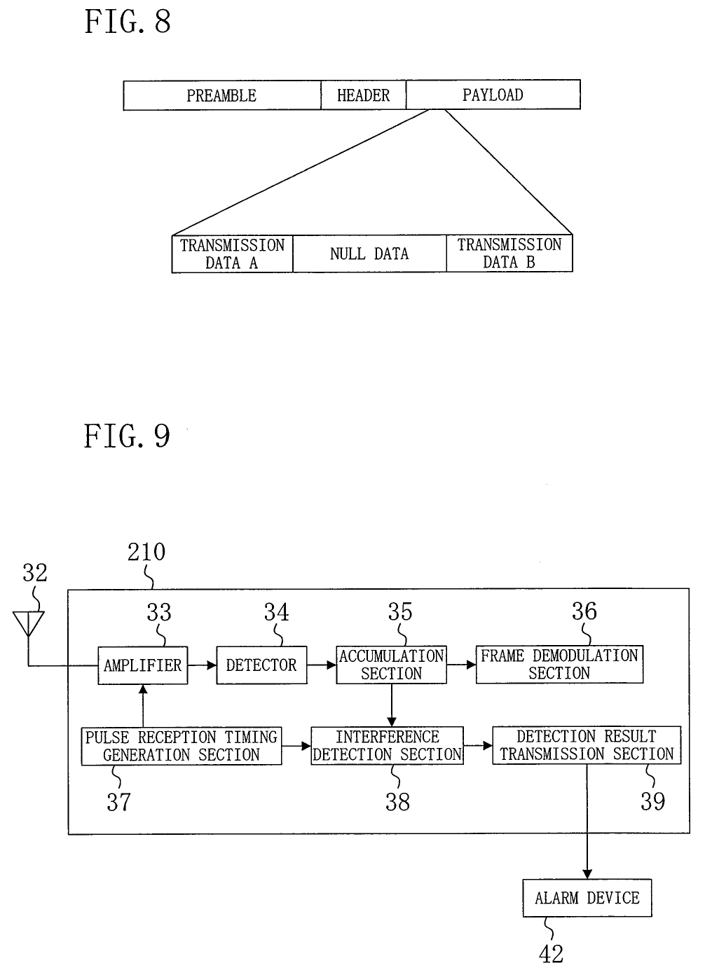

A transmitter and a receiver of an alteration to the embodiment of the present invention will be described. FIG. 8 is a view illustrating an example of a transmission frame having null data. In a transmitter 200 of this alteration, the transmission frame generation section inserts null data at a predetermined position in the payload part of the transmission frame as shown in FIG. 8. The pulse generation section does not generate pulses during the time period of the null data. In other words, the transmitter 200 does not transmit pulses during the null data time period. Except for this point, the transmitter 200 is the same in configuration as the transmitter 100 of FIG. 1.

FIG. 9 is a block diagram of a receiver 210 of the alteration to the embodiment of the present invention. The receiver 210 of FIG. 9 includes an interference detection section 38 and a detection result transmission section 39 in addition to the configuration of the receiver 110 of FIG. 2.

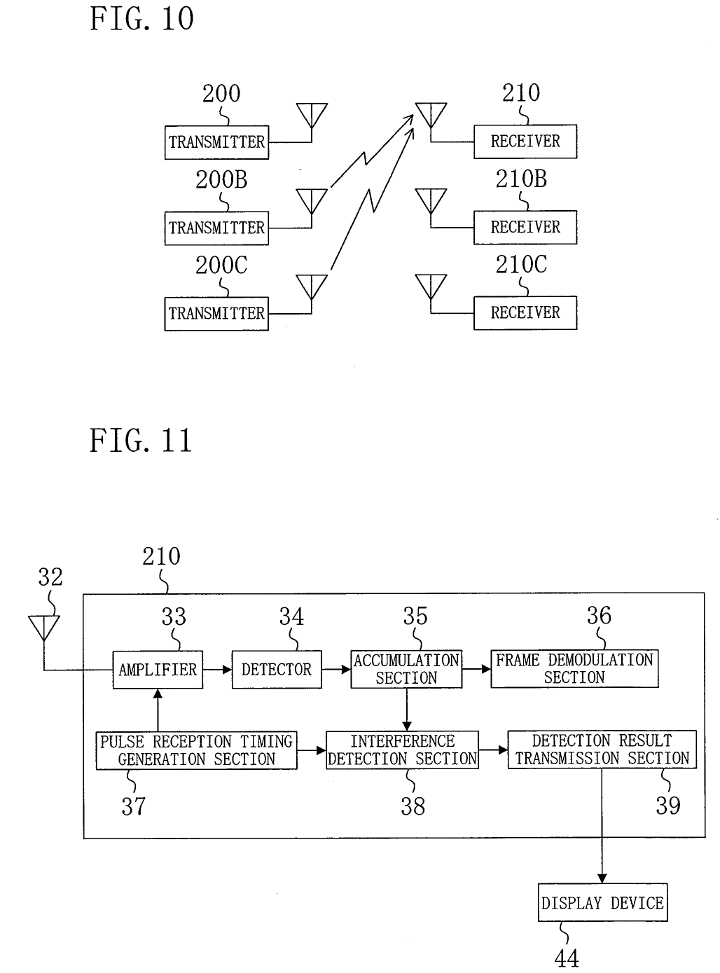

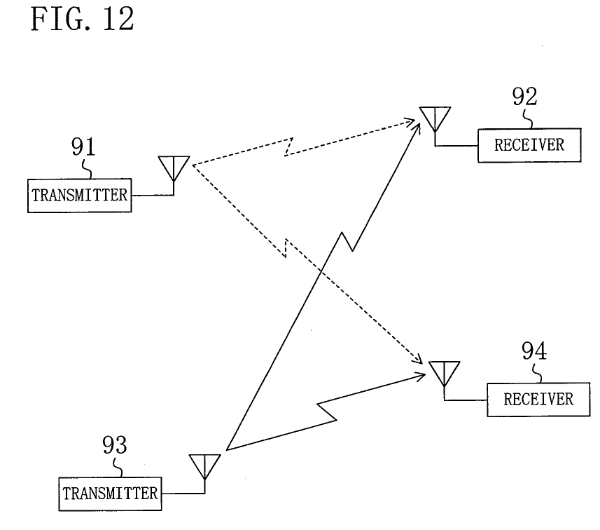

FIG. 10 is an illustration showing a state in which a plurality of transmitters substantially same as the transmitter of this alteration and a plurality of receivers substantially same as the receiver of FIG. 9 exist. Transmitters 200B and 200C are roughly the same in configuration as the transmitter 200, and receivers 210B and 210C are roughly the same in configuration as the receiver 210. The transmitter 200, the receiver 210 and an alarm device 42 as an output device constitute one communication terminal system, the transmitter 200B and the receiver 210B constitute another communication terminal system, and the transmitter 200C and the receiver 210C constitute yet another communication terminal system.

The transmitter 200 and the receiver 210 will be described focusing on the points different from the transmitter 100 and the receiver 110. The transmitter 200 does not transmit pulses during the time period of transmission of null data in the transmission frame (see FIG. 8). During the time period of reception of the null data transmitted from the transmitter 200, however, the receiver 210 receives pulses transmitted from the transmitters 200B and 200C.

The interference detection section 38 detects the transmitted pulses and outputs the detection result. Specifically, the interference detection section 38 acquires a value from the result of accumulation made by the accumulation section 35 during the time period of reception of the null data according to the pulse reception timing generated by the pulse reception timing generation section 37, and outputs the acquired value to the detection result transmission section 39 as the detection result. The detection result transmission section 39 compares the detection result with a predetermined threshold, and, if determining that the detection result is greater than the threshold, outputs a signal indicating occurrence of interference to the alarm device 42 located outside the receiver 210. The alarm device 42 then generates an audible alarm to notify the user of occurrence of interference.

FIG. 11 is a block diagram of a display device shown together with the receiver 210 of FIG. 9 connected therewith. The receiver 210 may only be connected with an output device which outputs the comparison result from the detection result transmission section 39 so as to be perceivable by the user of the receiver 210. In FIG. 11, in place of the alarm device 42, a display device 44 is connected with the receiver 210 as an example of the output device. The detection result transmission section 39 outputs the signal indicating occurrence of interference to the display device 44 located outside the receiver 210. The display device 44 then displays a message indicating occurrence of interference to notify the use of occurrence of interference.

The detection result transmission section 39 may be provided with a plurality of thresholds for determination of the pulse interference level, to compare the detection result from the interference detection section 38 with these thresholds and output the comparison result externally. In this case, the detection result transmission section 39 outputs an interference level signal indicating not only presence/absence of interference but also the interference level. For the receiver of FIG. 9, the alarm device 42, receiving the interference level signal, generates an audible alarm with a volume corresponding to this signal to notify the user of the level of the interference. For the receiver of FIG. 11, the display device 44, receiving the interference level signal, displays the interference level corresponding to this signal to notify the user of the level of the interference.

As described above, according to the embodiments of the present invention, the interference caused by a transmitter other than a specific transmitter can be reduced. Hence, the present invention may be useful for transmitters, receivers, and communication terminal systems and the like having transmitters and receivers.

While the disclosure has been described in preferred embodiments, it will be apparent to those skilled in the art that the disclosed invention may be modified in numerous ways and may assume many embodiments other than those specifically set out and described above. Accordingly, it is intended by the appended claims to cover all modifications of the invention which fall within the true spirit and scope of the invention.

What is claimed is:

1. A transmitter for conducting communication with a receiver using a pulse train, comprising:
a transmission frame generation section for generating a transmission frame;
a pulse transmission timing generation section for generating pulse transmission timing to have intervals initially set to be the same as intervals at which the receiver receives pulses; and
a pulse generation section for generating pulses according to the transmission frame and the pulse transmission timing generated by the pulse transmission timing generation section.

2. The transmitter of claim 1, wherein the pulse transmission timing generation section generates the pulse transmission timing to have the initially set intervals for a portion of the transmission frame following a predetermined position in the transmission frame.

3. The transmitter of claim 2, wherein the transmission frame generation section inserts a set value indicating the initially set intervals at a predetermined position in the transmission frame, and
the pulse transmission timing generation section generates the pulse transmission timing to have intervals corresponding to the set value after transmission of the set value.

4. The transmitter of claim 1, wherein the pulse transmission timing generation section generates the pulse transmission timing to have intervals corresponding to a predetermined random number sequence.

5. The transmitter of claim 1, wherein the pulse generation section has a time period of generating no pulse in response to a predetermined portion of the transmission frame.

6. A receiver for conducting communication with a transmitter using a pulse train, comprising:
a pulse reception timing generation section for generating pulse reception timing to have intervals initially set to be the same as intervals at which the transmitter transmits pulses;
an amplifier for amplifying a received signal according to the pulse reception timing generated by the pulse reception timing generation section;
a detector for demodulating a signal amplified by the amplifier and outputting the demodulation result;
an accumulation section for accumulating an output of the detector and outputting the accumulation result; and
a frame demodulation section for demodulating an output of the accumulation section and outputting a reception frame obtained.

7. The receiver of claim 6, wherein the pulse reception timing generation section generates the pulse reception timing to have the initially set intervals after the transmitter starts transmission of pulses at the initially set intervals.

8. The receiver of claim 7, wherein the pulse reception timing generation section retrieves a set value indicating a pulse interval inserted at a predetermined position in a transmission frame by the transmitter from the reception frame obtained in the frame demodulation section, and generates the pulse reception timing to have intervals corresponding to the retrieved set value.

9. The receiver of claim 6, wherein the pulse reception timing generation section generates the pulse reception timing to have intervals corresponding to a predetermined random number sequence.

10. The receiver of claim 6, further comprising:
an interference detection section for detecting a pulse transmitted from another transmitter during a time period for which the partner transmitter does not transmit pulses; and
a detection result transmission section for comparing a result of detection by the interference detection section with a predetermined threshold and outputting a comparison result.

11. A communication terminal system having a transmitter and a receiver for conducting communication using a pulse train,
wherein the transmitter comprises:
a transmission frame generation section for generating a transmission frame;
a pulse transmission timing generation section for generating pulse transmission timing to have initially set intervals; and
a pulse generation section for generating pulses according to the transmission frame and the pulse transmission timing generated by the pulse transmission timing generation section, and
the receiver comprises:
a pulse reception timing generation section for generating pulse reception timing to have intervals initially set to be the same as intervals at which the transmitter transmits pulses;
an amplifier for amplifying a received signal according to the pulse reception timing generated by the pulse reception timing generation section;
a detector for demodulating a signal amplified by the amplifier and outputting the demodulation result;
an accumulation section for accumulating an output of the detector and outputting the accumulation result; and
a frame demodulation section for demodulating an output of the accumulation section and outputting a reception frame obtained.

12. The communication terminal system of claim 11, wherein the pulse transmission timing generation section generates the pulse transmission timing to have the initially set intervals for a portion of the transmission frame following a predetermined position in the transmission frame, and
the pulse reception timing generation section generates the pulse reception timing to have the initially set intervals after the transmitter starts transmission of pulses at the initially set intervals.

13. The communication terminal system of claim 12, wherein the transmission frame generation section inserts a set value indicating the initially set intervals at a predetermined position in the transmission frame,
the pulse transmission timing generation section generates the pulse transmission timing to have intervals corresponding to the set value after transmission of the set value, and
the pulse reception timing generation section retrieves the set value indicating the pulse intervals inserted at the predetermined position in the transmission frame from the reception frame obtained in the frame demodulation section, and generates the pulse reception timing to have intervals corresponding to the retrieved set value.

14. The communication terminal system of claim 11, wherein the pulse transmission timing generation section generates the pulse transmission timing to have intervals corresponding to a predetermined random number sequence, and
the pulse reception timing generation section generates the pulse reception timing to have intervals corresponding to the predetermined random number sequence.

15. The communication terminal system of claim 11, further comprising an output device,
wherein the pulse generation section has a time period of generating no pulse in response to a predetermined portion of the transmission frame,
the receiver further comprises:
an interference detection section for detecting a pulse transmitted from another transmitter during the time period for which the partner transmitter does not transmit pulses; and
a detection result transmission section for comparing a result of detection by the interference detection section with a predetermined threshold and outputting a comparison result to the output device, and
the output device outputs the comparison result so as to be perceivable by a user of the receiver.

16. The communication terminal system of claim 15, wherein the output device is an alarm device for outputting sound in response to the comparison result.

17. The communication terminal system of claim 15, wherein the output device is a display device for performing display in response to the comparison result.

18. The communication terminal system of claim 15, wherein the detection result transmission section compares a result of detection by the interference detection section with a plurality of predetermined thresholds and outputting a comparison result to the output device.

19. The communication terminal system of claim 18, wherein the output device is an alarm device for outputting sound in response to the comparison result.

20. The communication terminal system of claim 18, wherein the output device is a display device for performing display in response to the comparison result.
